(19) United States
(12) Patent Application Publication
(10) Pub. No.: US 2015/0006288 A1
(43) Pub. Date: Jan. 1, 2015

(54) ONLINE ADVERTISING INTEGRATION MANAGEMENT AND RESPONSIVE PRESENTATION

(71) Applicant: TEN FARMS, INC., La Quinta, CA (US)

(72) Inventor: Nils Forsblom, La Quinta, CA (US)

(73) Assignee: TEN FARMS, INC., La Quinta, CA (US)

(21) Appl. No.: 13/958,419

(22) Filed: Aug. 2, 2013

Related U.S. Application Data
(60) Provisional application No. 61/841,318, filed on Jun. 29, 2013.

(51) Int. Cl. G06Q 30/02

(52) U.S. Cl. CPC G06Q 30/0251; G06Q 30/0256; G06Q 30/0267; G06Q 30/0269; G06Q 30/0277
USPC 705/14.54; 705/14.49; 705/14.64; 705/14.66

(57) ABSTRACT

The presentation of advertisements to a client device is disclosed. An advertisement delivery request with one or more targeting option parameters and a device type identifier corresponding to an output display configuration is received from an agent module embedded within content being rendered on the client device. A one of the advertisements is retrieved based on matching the targeting option parameters to each targeting option value assigned to the advertisement. The target option value corresponds to one of a plurality of targeting specificity levels along a breadth continuum, each of which may be associated with a definition applicable to the content. The retrieved one of the advertisements may include a plurality of variants, each of which are configured for a different output display configuration. One of the variants is transmitted to the client device, and corresponds to the output display configuration specified in the device type identifier.

### CROSS-REFERENCE TO RELATED APPLICATIONS

This application relates to and claims the benefit of U.S. Provisional Application No. 61/841,318 filed Jun. 29, 2013 and entitled “ONLINE ADVERTISING INTEGRATION MANAGEMENT AND PRESENTATION,” the entire contents of which is wholly incorporated by reference herein.

### STATEMENT RE: FEDERALLY SPONSORED RESEARCH/DEVELOPMENT

Not Applicable

### BACKGROUND

1. Technical Field

The present disclosure relates generally to online services and advertising, and more particularly, to presenting and managing the integration of advertising with online content providers.

2. Related Art

Although various business models exist in the field of online media, most involve providing information or services free of charge to the primary audience in exchange for being presented with advertising that is paid for by the respective advertisers. As discussed herein, online media or content providers encompasses the Internet counterparts of traditional television, radio, and print news and magazine outlets, as well as search engines and other such aggregators, social networking sites, individual websites/web logs (blogs) and the like. Compelling content and useful functionality is understood to attract more users, which in turn increases demand for the limited space from advertisers and thereby justifying an increased price. Advertising revenue is understood to offset the costs of server maintenance, network bandwidth, and other technical aspects, as well as the costs for producing the content itself, including pay for the authors, editors, and other personnel involved in production. Oftentimes advertisements are the sole source of revenue for many online media companies. Even in sites where users pay for content, the sale of advertising space may represent a significant revenue source.

There are a variety of ways in which advertising content can be integrated with the presentation of the primary content (news articles, etc.) One of the most common is the banner ad, which is a graphic designed by the advertiser and placed in a prominent location within a content page. Several technical solutions that achieve this functionality are known in the art, such as embedding the banner advertisement in-line with the content but laid out on the top, side, or bottom ends of the page, displaying the banner advertisement in a separate static frame that does not move when scrolling, and so forth. Besides static graphics, animations, sound, video and different interactive elements can be also be integrated into the banner ad. Clicking on the banner advertisement typically directs the user to the advertiser's website, where additional information and an opportunity to purchase the advertised product can be provided.

Other similar advertising display techniques are also known in the art. These include pop-up windows, floating advertisements that are overlaid on the content until some additional interaction (such as pressing a close button) is completed, and interstitial ads, which require a reader to view an advertisement before being provided access to the content page. As will be appreciated, these techniques vary in terms of obtrusiveness and effectiveness, and varying forms of online advertising can be deployed depending on the desires of the content provider, the advertiser, and the user base.

Regardless of specific way in which the advertisement is ultimately presented, payment is based upon one or more well-known metrics. One is based upon the number of times the underlying content page, and hence the banner ad, was displayed to a reader, similar to the way payment for print advertisements are derived from total circulation counts. This is referred to as Cost-Per-Mille (CPM), or the cost per thousand impressions. Because CPM may be susceptible to impression fraud, additional restrictions may be imposed on what constitutes a proper, countable delivery of the advertisement. One tracks the number of times the advertisement is clicked to access the advertiser's site, referred to as Cost-Per-Click (CPC). Still further, the number of times the advertisement is clicked and a desirable action is taken such as completing a registration form or a purchase may be the utilized metric, referred to as Cost-Per-Action (CPA). As an alternative or as a supplement to the foregoing metrics-based payments, a flat fee may be charged.

The tracking and delivery of advertisements is typically not handled by the individual content provider, but rather, by a third party advertisement service. There are several popular services, all of which negotiate rates with advertisers and provide the infrastructure for targeting the delivery of advertisements. The indiscriminate delivery of advertisements without regard to the tastes, interests, desires, and current circumstances of the audience to which the content is presented tends to be a wasteful exercise with dismal response rates. To increase the value of online advertisement from the perspective of both the advertisement service and the advertiser, various placement optimization tools have been developed. For instance, it may be possible to specify keywords within the content that is associated with a particular advertiser or advertisement. Embedding advertisements that may be related to a user's past actions is possible, as is targeted advertisements based on location. Various tools to track the progress of advertisement campaigns are also provided so that success or failure can be determined, and adjustments can be made where necessary. Existing advertisement services are limited with respect to context sensitivity, however, and do not afford the advertiser much control.

Advertisement graphics are typically designed on the assumption that it will be viewed on a web browser running on a conventional computer system having a standardized graphic output resolution. As such, most banner advertisement graphics have fixed standard dimensions and sizes. The aforementioned advertising service receives the standardized graphics for rendering in line with the content, which is laid out by the content provider with a placeholder with the corresponding dimensions.

With an increasing proportion of online content viewing being on smart phones and other small form factor devices with much less screen real estate than such typical graphics capabilities, unobtrusively rendering advertisements thereon with sufficient clarity represents a significant challenge. On one hand, the graphic cannot be so large/of high resolution that it occupies most of the screen, but it cannot be so small/of low resolution that its contents are illegible. The advertisement graphic is not scaled, so results on alternative displays is erratic at best.

Accordingly, there is a need in the art for improvements to the presentation and managing the integration of advertisement with online content providers. There is also a need for the improved targeting of advertisements by both advertisers and content providers alike, as well as the improved delivery of device-specific advertisement graphics.

### BRIEF SUMMARY

The present disclosure contemplates various methods for integrating advertisements stored in an advertising server system into a presentation of content stored in a content publishing system to a remote client system. The method may include receiving a graphic of one of the advertisements on the advertising server. Additionally, this may also include receiving one or more advertisement attributes defining the one of the advertisements. There may be a step of assigning one or more targeting option values to the one of the advertisements. Each of the targeting option values may correspond to one of a plurality of targeting specificity levels along a breadth continuum. Each of the targeting specificity levels may be associated with a definition applicable to the content. The method may also include receiving an advertisement delivery request from an agent module embedded within the content. The advertisement delivery request may include one or more targeting option parameters and may be generated by the agent module in response to the content being rendered on the remote client system. There may further be a step of retrieving the graphic of one of the advertisements based upon a matching of each of the one or more targeting values assigned to the one of the advertisements and the targeting option parameters included in the advertisement delivery request. The method may also include transmitting the graphic of the one of the advertisements to the remote client system.

Another embodiment of the present disclosure contemplates a method for presenting advertisements to a client device. The method may include receiving an advertisement delivery request from an agent module that is embedded within content that is being rendered on the client device. The advertisement delivery request may include one or more targeting option parameters. There may be a step of receiving a device type identifier from the client device. The device type identifier may correspond to an output display configuration thereof. The method may further include retrieving a one of the advertisements based upon a matching of the targeting option parameters included in the advertisement delivery request to each targeting option value assigned to the advertisement. The target option value may correspond to one of a plurality of targeting specificity levels along a breadth continuum, each of which may be associated with a definition applicable to the content. The retrieved one of the advertisements may also include a plurality of variants, each of which are configured for a different output display configuration. The method may also include transmitting one of the plurality of variants of the advertisements to the client device. This variant may correspond to the output display configuration for the device type identifier.

Yet another embodiment contemplates a method for presenting advertisements on a client device. The method may include transmitting a request for content stored in a content publishing system. In response, there may be a step of receiving the content from the content publishing system. The content may include an agent module embedded therein and one or more targeting option parameters. There may also be a step of transmitting an advertisement delivery request to an advertisement server system. This step may be performed by the agent module that is being executed on the client device as the content is being rendered thereon. The advertisement delivery request may include the one or more targeting option parameters and a device type identifier corresponding to an output display configuration of the client device. The method may further include receiving a first variant of a plurality of variants of an advertisement in response to the advertisement delivery request. The advertisement may be assigned one or more targeting option values each corresponding to one of a plurality of targeting specificity levels associated with definitions applicable to the content. The targeting option parameters may be matched to the targeting option values, and the first variant of the advertisement may be specific to the output display configuration of the client device. There may also be a step of displaying the first variant of the advertisement on the client device.

Certain other embodiments of the present disclosure contemplate respective computer-readable program storage media that each tangibly embodies one or more programs of instructions executable by a data processing device to perform the foregoing method. The present disclosure will be best understood accompanying by reference to the following detailed description when read in conjunction with the drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block diagram illustrating the environment in which various methods of the present disclosure may be implemented;

FIG. 2 is a block diagram depicting the various components of an advertisement server;

FIG. 3 is a flowchart showing the steps of one method for integrating advertisements into a presentation of content to a remote client system;

FIG. 4 is an example user interface of an advertiser dashboard in which configuration options may be defined;

FIG. 5 is an example graphic formatted according to predefined guidelines for optimal presentation;

FIG. 6 is an example user interface of the advertiser dashboard in which targeting option values are assigned;

FIGS. 7A-7E are graphical depictions of targeting functions in accordance with various embodiments of the present disclosure;

FIG. 8 is a flowchart showing the steps of a method for presenting advertisements on a client device;

FIG. 9 is a flowchart showing the steps of a method for presenting advertisements to the client device; and

FIG. 10 is a diagram of different variations of the advertisement that can be presented depending upon an output display configuration of the client device.

### DETAILED DESCRIPTION

The present disclosure encompasses various embodiments of methods for targeting and delivering advertisements without disturbing the user experience, both aesthetically and substantively. Envisioned are the flexible targeting of advertisements that can be intuitively configured, and ensuring the consistent presentation of advertisements over wide varieties display configurations. Audiences are no longer tethered to conventional desktop computers and are instead turning to smartphone, tablets, and other mobile devices to view content. The detailed description set forth below in connection with the appended drawings is intended as a description of the several presently contemplated embodiments of these methods, and is not intended to represent the only form in which the disclosed invention may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

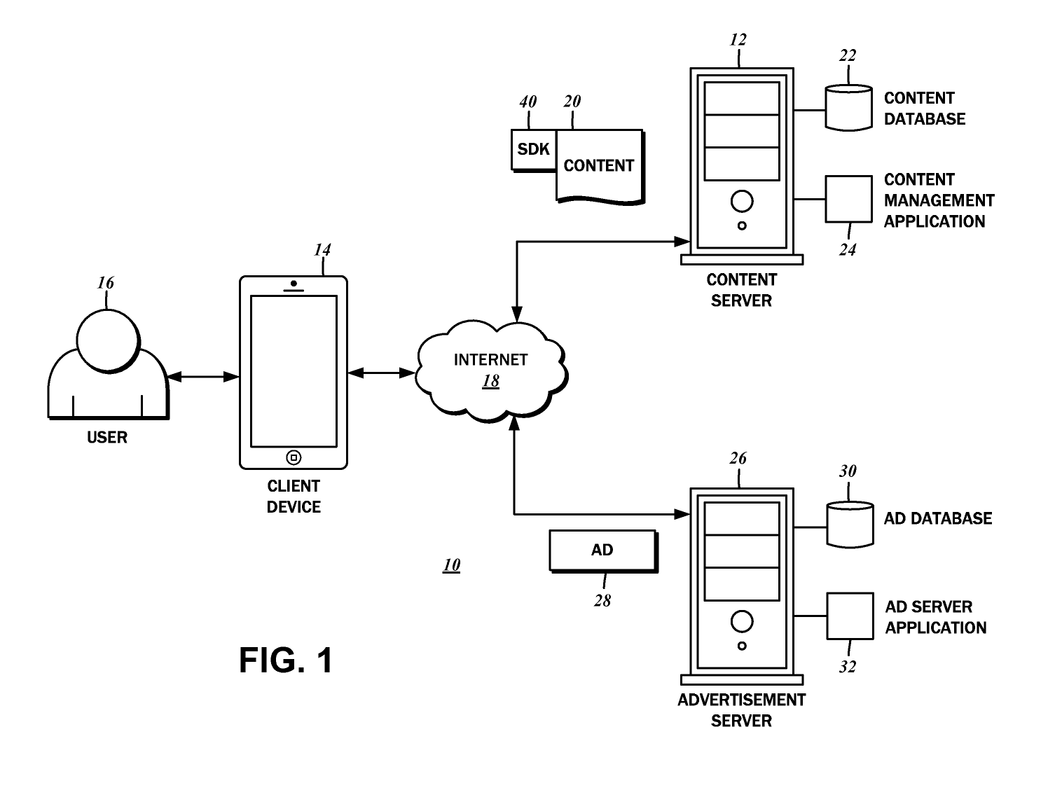

The block diagram of FIG. 1 depicts one exemplary networked computing environment 10 in which various embodiments of the disclosed methods of presenting advertisements may be implemented. A preferred, though optional application of the present disclosure is directed to advertising in news content, so the illustrative examples may be described in terms specific to the publishing and journalism industry. It will be recognized by those having ordinary skill in the art, however, that this is by way of example only and not of limitation, and that this disclosure may be applicable to any other setting where advertising is presented together with useful information or functions, including software applications, social networking websites, and so forth. In this regard, terms referenced herein specific to publishing may be substituted with equivalent terms in such alternative contexts.

Continuing with the online news publication example, there may be a content server 12 with data stored thereon that is retrieved by a client device 14 operated by a user 16. The client device 14 is understood to be a mobile communications apparatus that can connect to the Internet 18, such as a smartphone. A foundational feature of such an apparatus is to place and receive telephone calls over a cellular network, but conventional smartphones are capable of running a variety of software applications including web browsers that can retrieve HyperText Markup Language (HTML) document pages over the hypertext transfer protocol (HTTP) and render the same for viewing thereon. To this end, the client device 14 is understood to include a data processor that executes pre-programmed instructions, as well as a memory for storing these instructions and other data. On a very general level, the particular operands and execution sequence of the instructions may be governed by various input parameters provided from an input device, while the results of executing the instructions may be shown on an output device. In some variations of the client device 14, the input device and the output device may be a combined touch screen display, though it is possible to have separate input devices such as keypads, buttons, and slide switches.

The basic incoming and outgoing data communications functions are provided by a transceiver incorporated into the client device 14. Various operating modes such as different generations of GSM (Global System for Mobile Communications), EDGE (Enhanced Data rates for GSM Evolution), UMTS (Universal Mobile Telecommunications System), HSPA (High Speed Packet Access) and others are implemented by the transceiver. Local area wireless networking technologies such as IEEE 802.11x (WiFi) may also be implemented by the transceiver. It is by using one or more of the foregoing communications modalities that the client device 14 establishes a link to the Internet 18 to access the content server 12, for example.

The content server 12 may be a news website with various articles, i.e., content 20 that are available for download and viewing by the user 16. In this regard, the content server 12 may be a single computer system or multiple computer systems with processors, memory, and network interface devices managed by an operating system, on which a web service platform is running. As is well understood, the content 20 may include formatted text, images, and other multimedia data that can be appropriately rendered by the web browser application running on the client device 14. The content 20 may be stored in a content database 22. Although it may be possible to organize a large volume of articles according to a file system of the content server 12, in most cases a content management application 24 that collects, index, and publishes the information/articles stored in the content database 22 is utilized. Additional metadata that is used to organize and search for the content 20 may be also kept by the content management application 24. Furthermore, various personnel involved in content production, from writers, photographers, and editors can access the content management application 24 to perform their respective roles in bringing the content 20 to the user 16.

As discussed earlier, the news company or publisher that runs the content server 12 oftentimes outsources ad serving and management functions to a third party provider. However, even when managed internally, most functionality pertaining to advertising may be handled by an advertisement server 26 separate from the content server 12, though this is by way of example only. Like the content server 12, the advertisement server may be a single computer system or multiple computer systems with processors, memory, and network interface devices to connect to the internet 18, and managed by an operating system. In the most basic implementation, the content 20 includes a link to a specific advertisement 28, and when the content 20 is rendered by the browser on the client device 14, the client device 14 utilizes that link to retrieve the advertisement 28 for further rendering of the same. The advertisement 28, along with any others, is stored in an advertisement database 30. Again, organization of the advertisements 28 and the interface to access certain ones are provided by a web application, which in the illustrated example is depicted as an advertisement server application 32. Various embodiments of the present disclosure contemplate methods that are performed by the advertisement server application 32, and so will be discussed in further detail below.

It is envisioned that the particular methods implemented on the content server 12 and on the advertisement server 26 together present advertisements 28 that are relevant and most likely to be acted upon by the user 16 as being targeted to the specifics of the content 20. This presentation is to be integrated seamlessly as part of the user experience of viewing the site on mobile devices, which may have differing display characteristics.

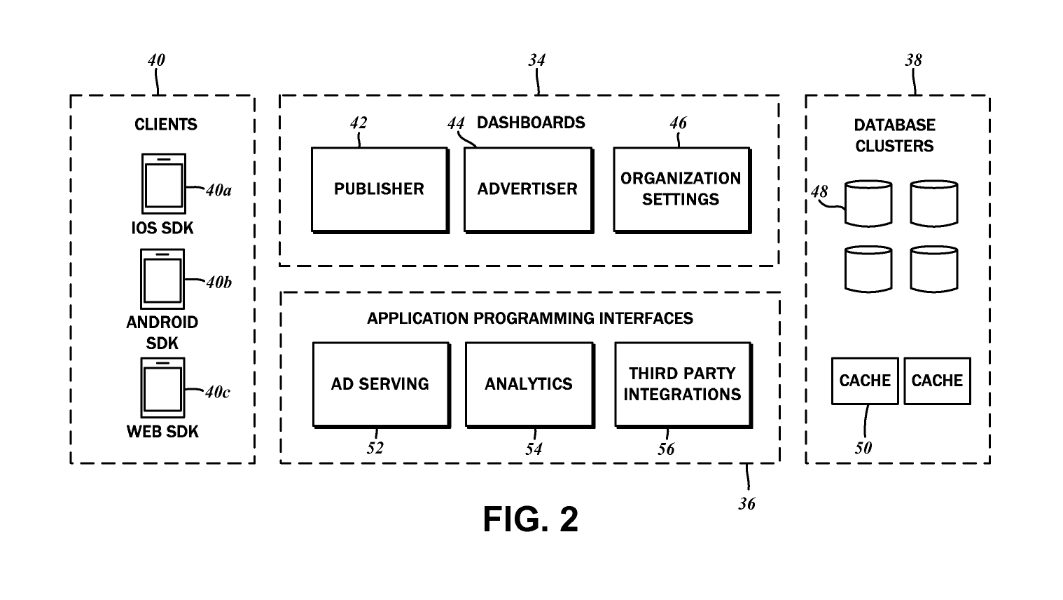

With reference to the block diagram of FIG. 2, the functional and data interfaces to the advertisement server 26 include dashboards 34, application programming interface 36, database cluster 38, and client interfaces 40. The various functions performed by the content server 12 are understood to be implemented as a series of pre-programmed instructions that are executed by the processor, and the aforementioned interfaces are utilized to access those functions.

Generally, the dashboards 34 serve as a modality for configuring various options and reviewing data relating to the operation of the advertisement server 26. The pertinence of different configuration options and reporting data may vary depending on the content publisher, the advertiser, or the advertisement service, so different dashboards 34 are configured for each. For example, tracking the progress of an advertising campaign and the amount of revenue being generated across all targeted advertisements presented through the site may be the more useful for the publisher, so such information may be provided via a publisher dashboard 42. The generated reports may include such information as click-through rates, which represent the percentage of impressions that led to an action, the number of actions, or the number of times the user 16 opened a website, made a phone call, sent an e-mail, and so forth, the revenue per mille (RPM), or the revenue per thousand impressions, and the revenue per click (RPC), or the revenue per paid action. Specific targeting strategies for the advertisements may be most pertinent to the advertiser, so setting those configuration options may be through an advertiser dashboard 44. Furthermore, there may be settings applicable across all publishers and advertisers and defined by an administrator of the advertisement service, so there may be a separate general configuration or organization setting dashboard 46.

As indicated above, the data for the advertisements 28 are stored in the advertisement database 30, which is equivalently depicted in the block diagram of FIG. 2 as the database clusters 38. It is contemplated that the database clusters 38 are comprised of an array of storage devices 48 that are configured in accordance with well-known high availability principles. Furthermore, data served by the advertisement server 26 may be temporarily stored in cache memory 50 to speed up access to the same.

External access to various functions of the advertisement server 26, and specifically the advertisement server application 32 is possible via the application programming interfaces 36. One of the primary functions of the advertisement server 26 is to transmit advertisements in response to a request. The request may include targeting parameters that generally specify which advertisement to deliver. This querying function to request the advertisement 28 may be made through an ad serving application programming interface (API) 52. As will be discussed in further detail below, an executable script embedded within the content 20 may invoke the functions available through the ad serving API 52. Another set of functions that may be useful to access from outside the dashboard context may be analytics concerning user responses to advertisements and so forth, and so an analytics API 54 may be provided. Other functions for integrating with third party services that add further utility to the functioning of the advertisement server 26 are possible via an third party integration API 56. The foregoing listing of application programming interfaces 36 is presented by way of example only and not of limitation, and any other suitable one may be provided without departing from the scope of the present disclosure.

The advertisement server 26 is also understood to serve advertisements 28 that are tailored to different platforms. The client interfaces 40 are understood to detect the platform of the client device 14 with which the advertisement server 26 is interacting, retrieve the appropriate advertisement 28, and transmit it to the client device 14. Accordingly, for each platform there is a separate client software development kit. For example, Apple iOS devices utilize an iOS software development kit 40a, and an Android device utilizes an Android software development kit 40b. General web browsers utilize a web software development kit 40c.

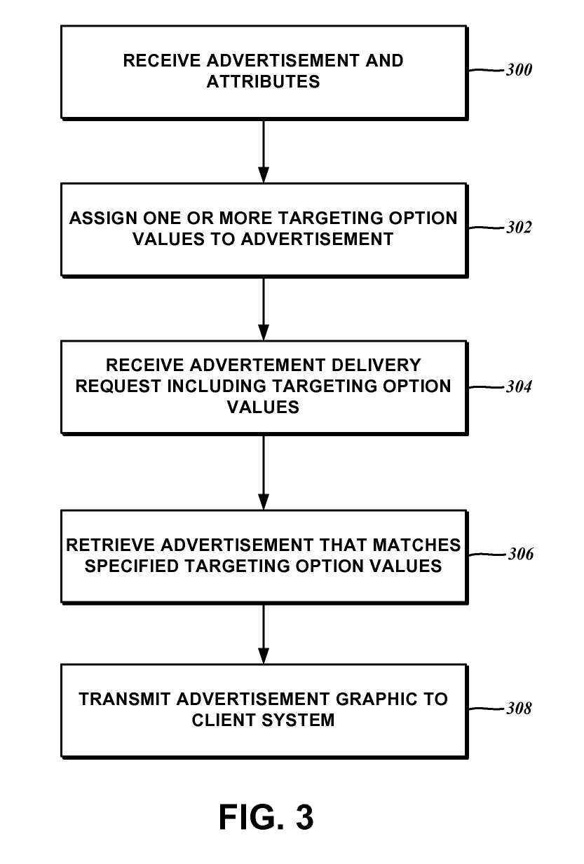

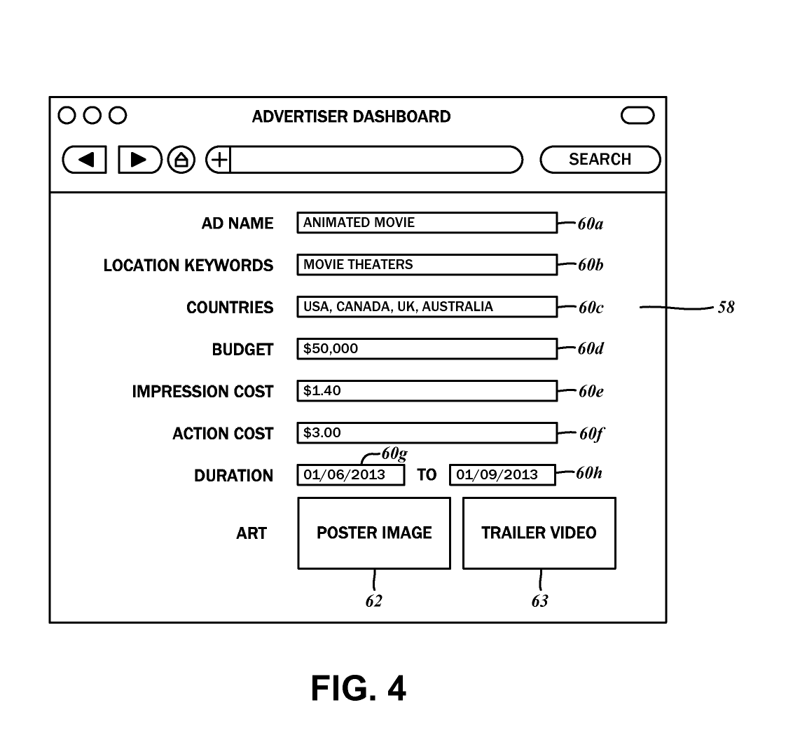

With reference to the flowchart of FIG. 3, a method for integrating the advertisements 28 into a presentation of the content 20 on the client device 14 begins with a precursor step 300 of receiving a graphic for an advertisement 28, along with one or more attributes that defines it. The graphic and the attributes are received on the advertisement server 26 via the aforementioned advertiser dashboard 44, and the advertisement as a data object processed by the advertisement server application 32 is defined. An exemplary interface 58 for the advertiser dashboard 44 is shown in FIG. 4, which may be accessed via a conventional web browser. The attributes include the name of the advertisement 28, specified via a first text entry field 60a, as well as location keywords that are specified via a second text entry field 60b and country designations that are specified via a third text entry field 60c. These geographic attributes may set the boundaries within which the client device 14 is located in order for the advertisement 28 to be presented. The limits may be set as inside a city, a state, a country, a designated market area (DMA), or a GPS radius. Various financial attributes such as the budget, specified via a fourth text entry field 60d, impression cost (the amount charged to the advertiser per view), specified via a fifth text entry field 60e, and action cost (the amount charged to the advertiser per additional action taken by the reader), specified via a sixth text entry field 60f. The duration for running the advertising campaign can be defined as between a start date specified in a seventh text entry field 60g and an end date specified in an eighth text entry field 60h.

The aforementioned graphic for the advertisement may be uploaded to the advertisement server 26 via an image upload button 62. Besides images (whether static or animated), video advertisements may also be uploaded to the advertisement server 26 via a video upload button 63. Although any image may be submitted, according to some embodiments, rules as to the formatting and contents may be set. Conventional image formats such as GIF (Graphic Interchange Format), PNG (Portable Network Graphics), JPG (Joint Pictures Expert Group) may be utilized. Static, as well as animated images are also possible. Rather than being interpreted as strict rules that result in the rejection of non-conforming guidelines, they may be regarded as guidelines instead. One guideline for the graphic may dictate a standard size of 300 by 250 pixels, while another may dictate a standard size of 320 by 480 pixels.

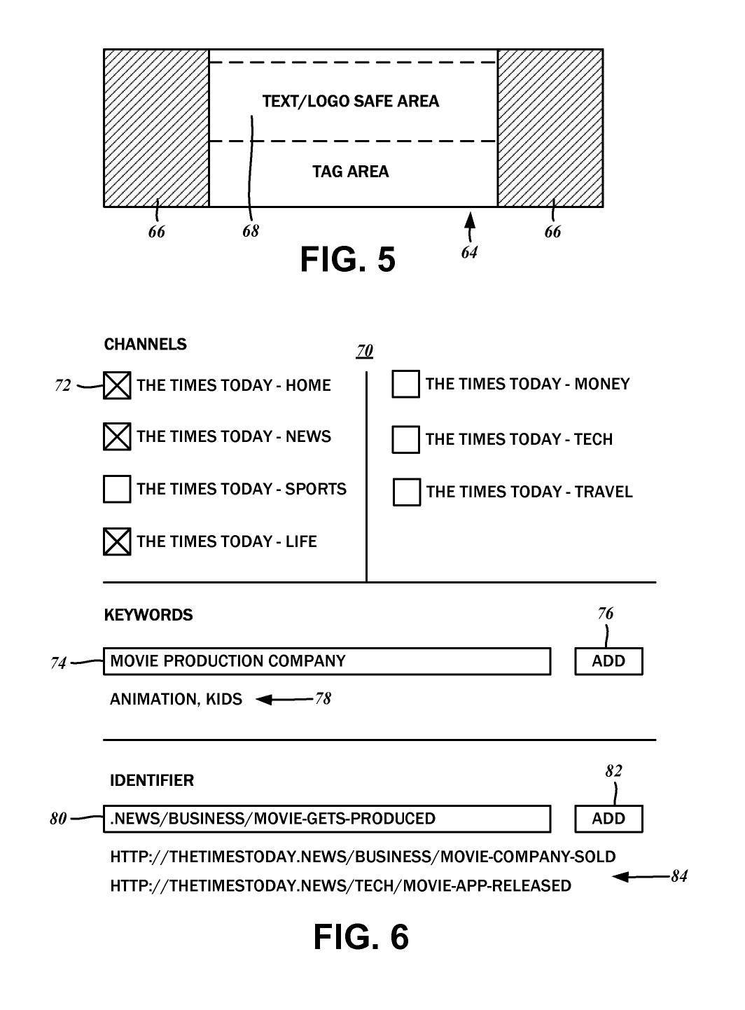

FIG. 5 depicts one exemplary embodiment of a graphic 64 for the advertisement 28 that is laid out in accordance with the aforementioned guidelines. There is a background image layer 66 that corresponds stylistically to the product or service being advertised. Additionally, in a separate layer, in particular, a text/logo layer 68, a title may be incorporated. By way of example, the title is to remain easy to read when scaled down to a smaller size, and should be kept to one line. With the text/logo layer 68 being separate from the background image layer 66, it is possible to independently position the text/logo layer 68 to where it would best fit the particular page with which the advertisement 28 will be displayed. Pixelation effects, artifacts, high-contrast background art, blurry or hard crops, unless intended to be stylistic, is to be avoided. Furthermore, to the extent any talent is incorporated into the graphic 64, all is to be kept visible. These guidelines may be set in order for the advertisement service to retain some measure of control and consistency when scaling to present the advertisement 28 to different display configurations.

Referring again to the flowchart of FIG. 3, the method of integrating advertisements also includes a further precursor step 302 of assigning one or more targeting option values to the advertisement 28. Various embodiments of the present disclosure contemplate a multi-level targeting strategy for correlating content to advertisements that range from broad to the specific, that is, along a breadth continuum. In defining the advertisement 28, specific targeting strategies that match to the content 20 can be configured. Targeting at different levels of breadth or specificity can be set individually, or combined with each other. Additionally, some targets may be left undefined, such that the advertising 28 can appear anywhere.

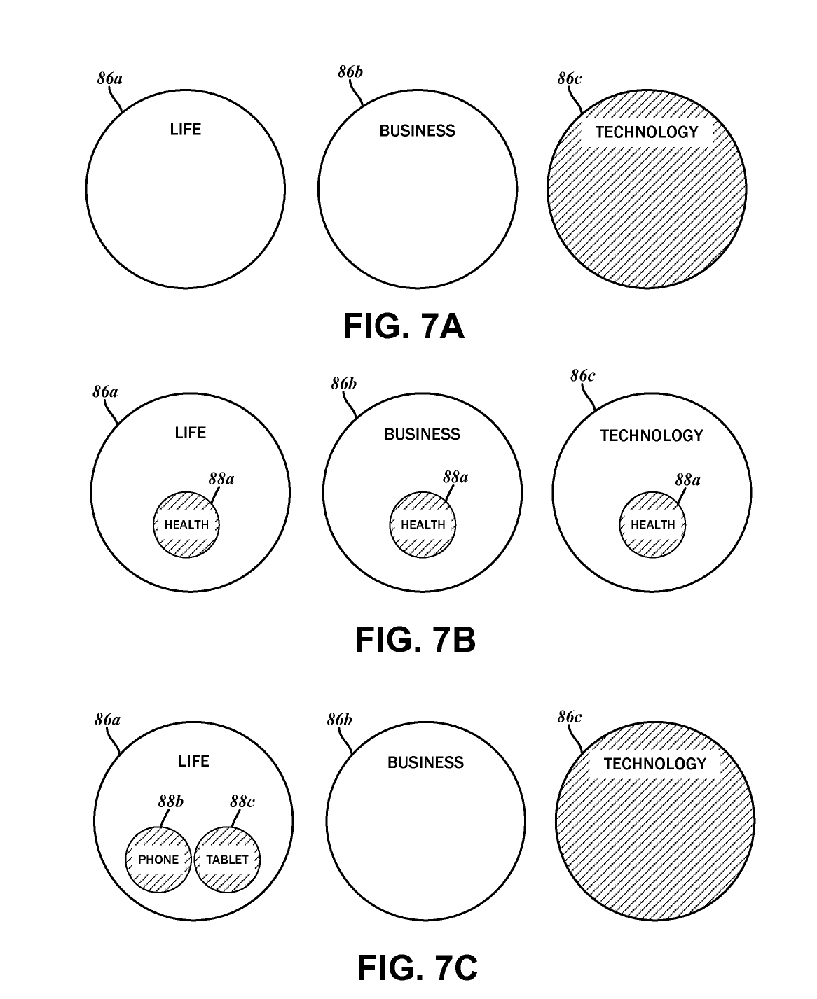

According to one exemplary embodiment, the broadest or least specific targeting is at a channel level, which, in the context of the news site, encompasses one or multiple news categories. In this regard, the channel is understood to refer to the targeting specificity level, while the specifically selected channel is understood to refer to the targeting option value. Defining targeting at the channel level is understood to allow the advertisement 28 to be displayed in conjunction with a variety of content. With reference to FIG. 6, a graphical interface to the advertiser dashboard 44 includes a listing 70 of seven channels, with home, news, sports, life, money, tech, and travel. Selection of the channel is input via the corresponding checkbox 72 adjacent to the descriptor of the channel.

When the content 20 is written and added to the content management application 24, these categories or channels may be assigned. Thus, the content producer, that is, the administrator of the content server 12, defines the channels. Each of the articles categorized under a given channel are understood to share a common characteristic. For example, all articles under the sports channel have some relation to sports news. It is expressly contemplated that the use of the term channel is by way of example only and not of limitation, and any other suitable term that refers to a collection of related content can be substituted.

A more specific targeting is at a keyword level. The category or targeting based on a keyword refers to the targeting specificity level, while the selected keyword refers to the targeting option value. Keyword targeting matches the specified keyword to those contained in the content 20, which may already exist for search engine optimization purposes. Targeting based on keywords can be combined with targeting based on channels. In other words, the assigned targeting option values can span multiple targeting specificity levels. With regard to combining keyword and channel targeting, it is also possible to further define specific keywords applicable only to the designated channel(s), i.e., sub-channel targeting, or define keywords that are applicable to all channels, i.e., global targeting.

Referring again to the FIG. 6, keywords can be specified for the advertisement from the interface to the advertiser dashboard 44. Specifically, there is a text entry field 74 in which the desired keyword can be entered, and the addition can be committed after pressing an add button 76. Existing keywords that have already been designated for the advertisement 28 are shown in a listing 78.

The advertisements 28 may be targeted at an even narrower targeting specificity level, that is, to single pages and/or articles. In order for the content management application 24 to individually reference each item of content that is available, a unique identifier is assigned thereto. The advertisement 28 can be defined to include targeting option values with these identifiers. Alternatively, the Uniform Resource Locator (URL) of the content 20 as designated by the content management application 24 may be specified. Similar to setting the keywords, as shown in FIG. 6, the identifiers can be added or modified via the interface to the advertiser dashboard 44, and specifically a text entry field 80. Once entered in the text entry field 80, pressing the add button 82 commits the change to the advertisement server 26. Furthermore, all of the identifiers that have been set as targeting option values are shown in a listing 84.

From the foregoing, it will be recognized that the targeting specificity levels, that is, channels, keywords, and content identifiers, all relate to some aspect or definition that is applicable to the content 20. It is understood that many of the values used to defining the advertisement 2 may already exist in the content 20, so integrating the advertisement server 26 of the present disclosure with the existing data of the content server 12 may require a minimal additional effort.

In order for the content 20 to be included within a target set with which a given advertisement 28 is to be presented, the content 20 is understood to include a client interface 40 or software development kit (SDK), also referred to as an agent module, embedded therein. The applicable channel or keyword that pertains to the content, also referred to as the targeting option parameters, is set or predefined in the client interface 40, and passed to the advertisement server 26 when the content 20 is being rendered on the client device 14. It is contemplated that the identifier, if it is the alternative embodiment of a URL, may be derived from the file system path without being expressly set. Only the targeting option values that are used need be provided to the advertisement server 26, and because a client interface 40 is configured separately for each item of content 20, adoption across the content server 12 may be gradual. According to one embodiment, the targeting option parameter is encoded within the content 20, and the client interface 40 is implemented in JavaScript.

From the perspective of the advertisement server 26, the method for integrating advertisements continues with a step 304 of receiving the aforementioned content option parameters as an advertisement delivery request. In response to this, there is a step 306 of retrieving an advertisement 28 having the targeting option values that match or otherwise correspond to the targeting option parameters set for the particular content 20. This step may further include retrieving the graphic 64 for the advertisement 28.

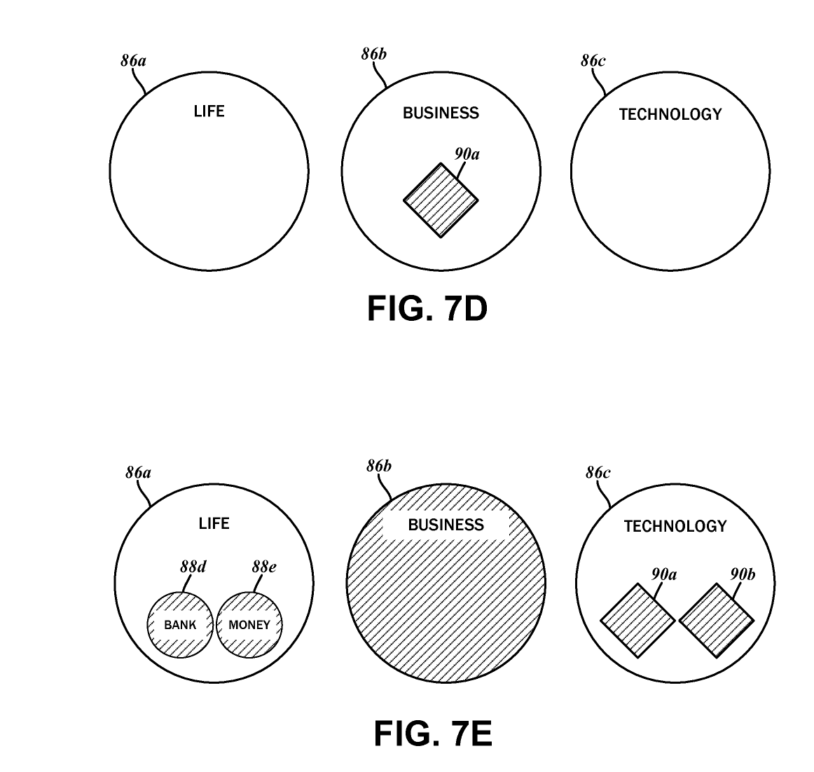

As generally described above, the advertisement 28 may be configured with targeting option values of differing specificity, e.g., channels, keywords, and identifiers. Each of these is graphically depicted in FIGS. 7A-7E, each illustrating an example targeting strategy. For exemplary purposes, there are three channels 86: a life channel 86a, a business channel 86b, and a technology channel 86c. FIG. 7A in particular depicts targeting an entire channel, e.g., the technology channel 86c. This means that the particular advertisement 28 may be presented whenever the content 20 associated with the technology channel 86c is presented. FIG. 7C depicts the global targeting of content 20 containing a health keyword 88a. Thus, regardless of the channel 86, the advertisement 28 may be displayed whenever content pertaining to health is presented.

FIG. 7C depicts targeting the technology channel, along with a phone keyword 88a and a tablet keyword 88b. In this situation, the keywords are also set globally, so the keyword targeting is not limited to the selected technology channel 86c, and any content 20 that includes the keyword may be presented with the advertisement 28. One possible application is where the advertisement 28 pertains to a newly released smart phone that is technologically revolutionary. Thus, the ad may be targeted to the technology channel 86c, and because the advertisement 28 concerns a consumer device, any articles having the phone keyword 88b and the tablet keyword 88c may also be targeted.

FIG. 7D depicts targeting the advertisement 28 to a specific content identifier 90. As discussed in greater detail above, identifiers are understood to be unique and target single items, regardless of its membership in a particular channel 86 or its inclusion of a particular keyword 88. The identifiers can be used in combination with the channels 86 and the keywords 88, as shown in FIG. 7E. There are two identifiers 90a and 90b, which happen to be content 20 in the technology channel 86c. Moreover, the entirety of the business channel 86b is targeted, along with a bank keyword 88d and a money keyword 88e. In this way, other content 20 that may not be included by the selection of a single channel 86, but not necessarily applicable to all of the content 20 in another channel 86, may be targeted.

Following the selection and retrieval steps, the method for integrating the advertisements include a step 308 of transmitting the graphic 64 of the retrieved advertisement 28 to the client device 14. Upon reception by the client device 14, the advertisement 28 may be presented to the user in a variety of different ways. One technique is disclosed in co-pending U.S. patent application Ser. No. 13/441,636 entitled “LOCATION SENSITIVE ADVERTISEMENT DELIVERY AND PRESENTATION” and filed Apr. 6, 2012, as well as International Application No. PCT/US13/30245 entitled “LOCATION SENSITIVE ADVERTISEMENT DELIVERY AND PRESENTATION and filed Mar. 11, 2013, the entirety of each of the disclosures of which are hereby incorporated by reference.

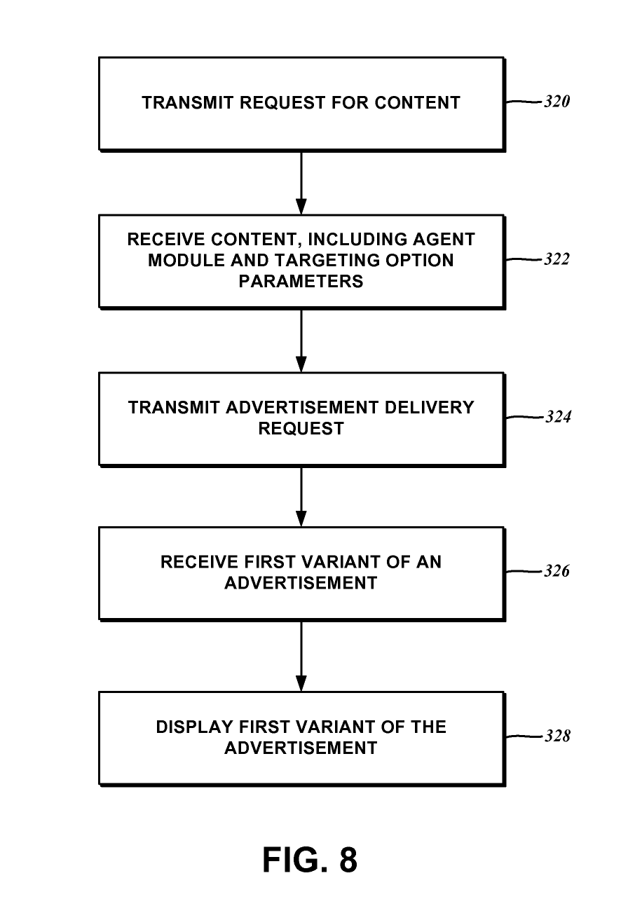

Another aspect of the present disclosure is directed to the presentation of advertisements that are specific to the output display configurations of the client devices 14 requesting them. In this regard, a method for presenting advertisements on the client device 14 is contemplated, and will be described with reference to the flowchart of FIG. 8. From the perspective of the client device 14, there are several precursor steps that are independent of the advertisement server 26 and do not involve any advertisements 28. There is a step 320 of transmitting a request for the content 20 stored on a content publishing system, that is, the content server 12. This step may be initiated when the user 16 makes a request to retrieve an article or a web page of interest. The content server 12 responds with the requested article or page, as per step 322. As indicated above, embedded within the content 20 is an agent module 40 that communicates with the advertisement server 26, along with the targeting option parameters for that particular content 20.

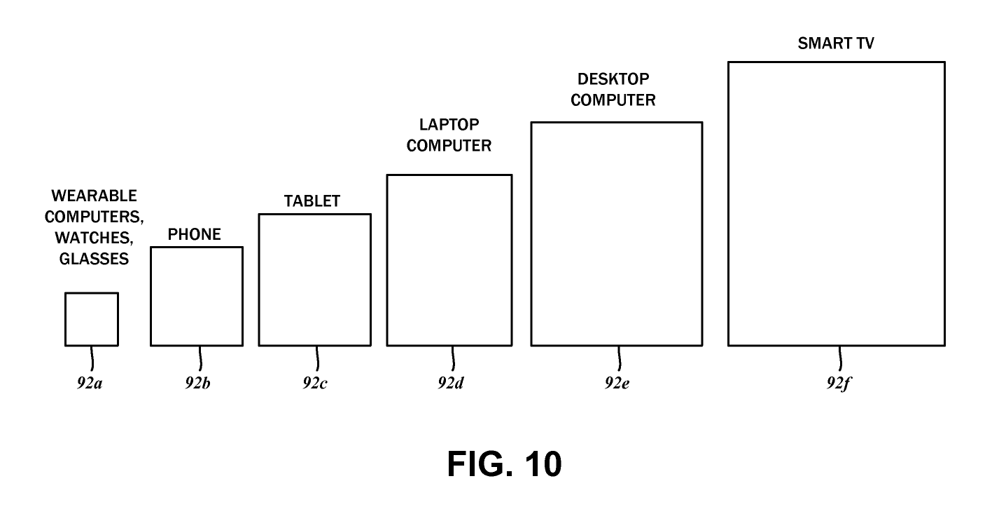

Additionally, the content 20 may include break points for different output display configurations that allow for the retrieval of a specific variation of the advertisement 28. FIG. 10 illustrates various contemplated form factors including a first variant 92a for wearable computing devices, watches, glasses, and the like, a second variant 92b for smart phone type devices, a third variant 92c for tablet devices, a fourth variant 92d for laptop and other smaller screen computer systems, a fifth variant 92e for desktop computer systems, and a sixth variant 92f for smart televisions and other large scale displays. Each of the variants 92a-92f is understood to have different scaling factors appropriate for the display. It is also possible for each variant to have a different message, a banner color, an advertisement size, and color design. As needs of the same user 16 may vary depending on the device or form factor on which the content 20 is being viewed, different messages and designs for each are contemplated. In other words, advertisers can share a different engagement on different media.

The earlier described step 304 of receiving the advertisement delivery request in the method for integrating advertisements has a precursor step 324 of transmitting the advertisement delivery request in the method for presenting advertisements on the client device 14. Again, this step may be performed by the agent module 40 that is executed on the client device 14. Included with the advertisement delivery request is one or more of the targeting option parameters that define which advertisements 28 are targeted for which content 20, as well as a device type identifier that correspond to the output display configuration of the client device 14. The breakpoints in the content 20 may be encountered during the initial rendering thereof, and so the step 324 of transmitting the advertisement delivery request and the device type identifier may take place thereafter. Alternative embodiments in which all of the variants 92a-92f are first retrieved, and only the one that corresponds to the device type identifier being rendered are also possible.

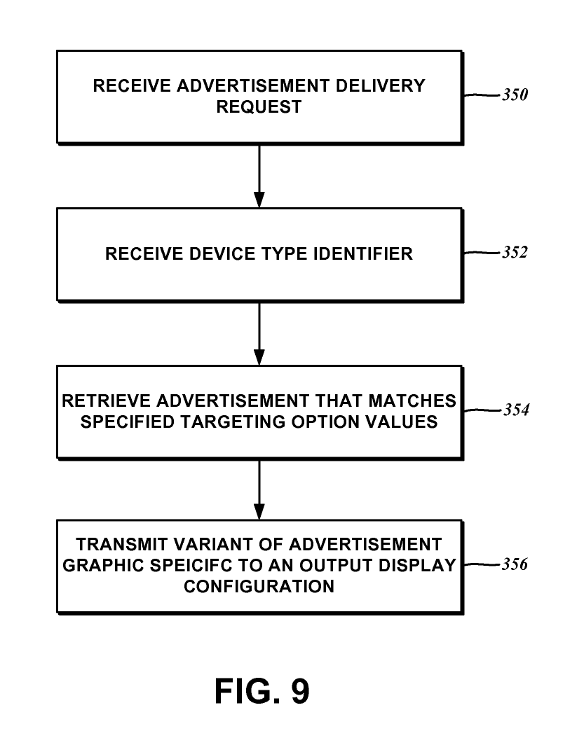

A different embodiment for presenting advertisements to the client device 14 from the perspective of the advertisement server 26 is also contemplated, the detailed steps of which are shown in the flowchart of FIG. 9. The step 304 discussed above has an equivalent step 350 in this method, of receiving the advertisement delivery request. There is also a step 352 of receiving the device type identifier. In response to the advertisement delivery request, the advertisement server 26 responds with retrieving an advertisement 28 that matches the specified targeting option values as discussed above, per step 354. Additionally, the variant 92 that corresponds the device type identifier may be retrieved. It is also possible to retrieve all variants, with the selection of the one of the variants 92 being made just prior to transmission to the client device 14 per step 356. Although the foregoing steps of retrieving the variants 92 involves the additional selection of advertisements 28 that are matched based on the targeting option values, this is not a necessity, and alternative embodiments with this aspect omitted are also deemed to be within the scope of the present disclosure.

Returning to the method being performed on the client device 14, the next step 326 is receiving the variant of the advertisement that corresponds to the specified device type identifier. Additionally, in step 328, the variant is displayed on the client device 14.

The particulars shown herein are by way of example and for purposes of illustrative discussion of the embodiments of the present disclosure only and are presented in the cause of providing what is believed to be the most useful and readily understood description of the principles and conceptual aspects. In this regard, no attempt is made to show details of the present invention with more particularity than is necessary, the description taken with the drawings making apparent to those skilled in the art how the several forms of the present invention may be embodied in practice.

What is claimed is:

1. A method for integrating advertisements stored in an advertising server system into a presentation of content stored in a content publishing system to a remote client system, the method comprising:
receiving on the advertising server a graphic of one of the advertisements and one or more advertisement attributes defining the one of the advertisements;
assigning to the one of the advertisements one or more targeting option values, each of the targeting option values corresponding to one of a plurality of targeting specificity levels along a breadth continuum and each of the targeting specificity levels being associated with a definition applicable to the content;
receiving an advertisement delivery request from an agent module embedded within the content, the advertisement delivery request including one or more targeting option parameters and being generated by the agent module in response to the content being rendered on the remote client system;
retrieving the graphic of one of the advertisements based upon a matching of each of the one or more targeting values assigned to the one of the advertisements and the targeting option parameters included in the advertisement delivery request; and
transmitting to the remote client system the graphic of the one of the advertisements.

2. The method of claim 1, wherein one of the targeting specificity levels is a content channel, the content being categorized under the content channel as sharing one or more common elements between other content categorized under the same content channel.

3. The method of claim 1, wherein one of the targeting specificity levels is a keyword included in the content.

4. The method of claim 1, wherein the assigned targeting option values span multiple targeting specificity levels.

5. The method of claim 4, wherein:
a first one of the targeting specificity is a content channel, the content being categorized under the content channel as sharing one or more common elements between other content categorized under the same content channel; and
a second one of the targeting specificity levels is a keyword included in the content; and

6. The method of claim 5, wherein the advertisement corresponding to the retrieved graphic has a first targeting option value specifying the content channel and a second targeting option value specifying the keyword.

7. The method of claim 5, wherein the advertisement corresponding to the retrieved graphic has a first targeting option value specifying the content channel.

8. The method of claim 5, wherein the advertisement corresponding to the retrieved graphic has a first targeting option value specifying the keyword.

9. The method of claim 5, wherein:
one of the targeting specific levels is a uniform resource locator (URL) of the content relative to the content publishing system; and
the advertisement corresponding to the retrieved graphic has a first targeting option value specifying the URL.

10. The method of claim 1, wherein one of the targeting specific levels is a URL of the content relative to the content publishing system.

11. The method of claim 10, further comprising:
retrieving the URL of the content; and
setting the retrieved URL of the content as a first targeting option value.

12. The method of claim 1, wherein the agent module and the targeting option parameters therefor are statically encoded within the content.

13. The method of claim 1, wherein the remote client system is a smart phone.

14. A method for presenting advertisements to a client device, the method comprising:
receiving an advertisement delivery request from an agent module embedded within content being rendered on the client device, the advertisement delivery request including one or more targeting option parameters;
receiving a device type identifier from the client device, the device type identifier corresponding to an output display configuration thereof;
retrieving a one of the advertisements based upon a matching of the targeting option parameters included in the advertisement delivery request to each targeting option value assigned to the advertisement and corresponding to one of a plurality of targeting specificity levels along a breadth continuum each associated with a definition applicable to the content, the retrieved one of the advertisements including a plurality of variants each configured for a different output display configuration; and
transmitting to the client device one of the plurality of variants of the advertisements corresponding to the output display configuration for the device type identifier.

15. The method of claim 14, wherein a first one of the plurality of variants and a second one of the plurality of variants have different displayable messages.

16. The method of claim 14, wherein a first one of the plurality of variants and a second one of the plurality of variants have different banner colors.

17. The method of claim 14, wherein a first one of the plurality of variants and a second one of the plurality of variants have different sizes.

18. The method of claim 14, wherein a first one of the plurality of variants and a second one of the plurality of variants have different color matching.

19. The method of claim 14, wherein the remote client device is a smart phone.

20. A method for presenting advertisements on a client device, the method comprising:
transmitting a request for content stored in a content publishing system;
receiving the content from the content publishing system, the content including an agent module embedded therein and one or more targeting option parameters;
transmitting, by the agent module executed on the client device as the content is being rendered thereon, an advertisement delivery request to an advertisement server system, the advertisement delivery request including the one or more targeting option parameters and a device type identifier corresponding to an output display configuration of the client device;
receiving a first variant of a plurality of variants of an advertisement in response to the advertisement delivery request, the advertisement being assigned one or more targeting option values each corresponding to one of a plurality of targeting specificity levels associated with definitions applicable to the content, to which the targeting option parameters are matched, and the first variant of the advertisement being specific to the output display configuration of the client device; and
displaying the first variant of the advertisement on the client device.

21. The method of claim 20, wherein the first variant and a second variant of the advertisement have different displayable messages.

22. The method of claim 20, wherein the first variant and a second variant of the advertisement have different banner colors.

23. The method of claim 20, wherein the first variant and a second variant of the advertisement have different sizes.

24. The method of claim 20, wherein the first variant and a second variant of the advertisement have different color matching.

25. An article of manufacture comprising a non-transitory program storage medium readable by a computer, the medium tangibly embodying one or more programs of instructions executable by the computer to perform a method for presenting advertisements on a client device, the method comprising:
transmitting a request for content stored in a content publishing system;
receiving the content from the content publishing system, the content including an agent module embedded therein and one or more targeting option parameters;
transmitting, by the agent module executed on the client device as the content is being rendered thereon, an advertisement delivery request to an advertisement server system, the advertisement delivery request including the one or more targeting option parameters and a device type identifier corresponding to an output display configuration of the client device;
receiving a first variant of a plurality of variants of an advertisement in response to the advertisement delivery request, the advertisement being assigned one or more targeting option values each corresponding to one of a plurality of targeting specificity levels associated with definitions applicable to the content, to which the targeting option parameters are matched, and the first variant of the advertisement being specific to the output display configuration of the client device; and
displaying the first variant of the advertisement on the client device.
